(19) United States
(12) Patent Application Publication
(10) Pub. No.: US 2014/0336984 A1
(43) Pub. Date: Nov. 13, 2014

(54) CONDITIONAL MONITORING OF INDUSTRIAL SYSTEMS

(71) Applicant: ABB Technology AG., Zurich (CH)

(72) Inventor: KEVIN DALE STARR, Lancaster, OH (US)

(21) Appl. No.: 13/928,439

(22) Filed: Jun. 27, 2013

Related U.S. Application Data
(60) Provisional application No. 61/822,561, filed on May 13, 2013.

(51) Int. Cl. G06F 11/34

(52) U.S. Cl. CPC G06F 11/3409
USPC 702/183

(57) ABSTRACT

Performances of components of an industrial system are conditionally monitored as a function of key performance indicator data by defining baseline key performance indicator values for raw data obtained by data sensors from the operation of the components, and diagnostic rules to triggering alarms by comparing baseline key performance indicator values to thresholds. Generated alarms are stored in association with the historic raw diagnostic data, times of acquisition of the historic raw data and times of generation of the alarms. Generated alarms are analyzed as a function of the said stored data and times to identify a correlation between different ones of the key performance indicators that are indicative of a required level of intervention, and the diagnostic rules are revised to initiate reporting of generated alarms pursuant to levels of intervention indicated by said correlations.

### CROSS-REFERENCE TO RELATED APPLICATION

This application is a continuation, and claims priority, of a U.S. provisional patent application by Kevin Starr for CONDITIONAL MONITORING OF INDUSTRIAL SYSTEMS, filed in the U.S. Patent and Trademark Office on May 13, 2013 and assigned Ser. No. 61/822,561, confirmation number 4433.

### FIELD OF THE INVENTION

Embodiments of the present invention relate to deploying on-site monitoring and diagnostic analysis that is responsive to conditional key performance indicators within an industrial system or process.

### BACKGROUND

Service experts use various methods for collecting and analyzing customer diagnostic information for troubleshooting industrial process implementations. Specific implementations may occur only occasionally with regard to similar processes, data inputs and benchmarks, and therefore experts must often relearn an appropriate method and application for each new job.

Automation services may provide software and hardware tools that automate known diagnostic methods for use by experts, making them consistent, repeatable, expeditious, and sometimes simpler, when applied to a given industrial process. However, large pluralities of different industrial processes implemented within a plant or other large enterprise present challenges to efficiently applying automated diagnostic tools and interpreting data generated by such tools. Applying different tools and as well as gathering information outputs from the tools generally requires a technician to travel to an on-site location, manually select appropriate tools, harmonize and interpret outputs from a variety of different software and hardware formats, and otherwise use expert discretion is selecting and managing the diagnostic process. Such on-site, expert management requirements defeat many of the efficiencies gained from the application of the automated diagnostic tools over manual expert technician services.

### BRIEF SUMMARY

In one aspect of the present invention, a method for conditionally monitoring the performance of components of an industrial system as a function of key performance indicator data includes a processing unit defining baseline key performance indicator values for raw data obtained by data sensors from the operation of each of a plurality of components of an industrial process, and diagnostic rules for triggering alarms as a function of comparing the baseline key performance indicator values to alarm thresholds. The processing unit initiates generating of alarm output data as a function of applying the defined diagnostic rules to historic raw diagnostic data stored in a data repository that is generated by the data sensors during operation of the industrial process components. The processing unit initiates storing in the data repository of the generated alarms in association with the historic raw diagnostic data and with times of acquisition of the historic raw data and times of generation of the alarms. One or more of the generated alarms are analyzed as a function of the historic raw diagnostic data and the times of acquisition of the historic raw data to identify a correlation between different (first and second) ones of the key performance indicators that is indicative of a level of intervention required by a service provider for said one generated alarm. The processing unit thus revises one of the diagnostic rules into a revised diagnostic rule that initiates reporting of said one or more generated alarms out to a service provider pursuant to the level of intervention indicated by the correlation of the different, first and second key performance indicators.

In another aspect, a system has a processing unit, computer readable memory and a tangible computer-readable storage medium with program instructions, wherein the processing unit, when executing the stored program instructions, defines baseline key performance indicator values for raw data obtained by data sensors from the operation of each of a plurality of components of an industrial process, and diagnostic rules for triggering alarms as a function of comparing the baseline key performance indicator values to alarm thresholds. The processing unit initiates generating of alarm output data as a function of applying the defined diagnostic rules to historic raw diagnostic data stored in a data repository that is generated by the data sensors during operation of the industrial process components. The processing unit initiates storing in the data repository of the generated alarms in association with the historic raw diagnostic data and with times of acquisition of the historic raw data and times of generation of the alarms. One or more of the generated alarms are analyzed as a function of the historic raw diagnostic data and the times of acquisition of the historic raw data to identify a correlation between different (first and second) ones of the key performance indicators that is indicative of a level of intervention required by a service provider for said one generated alarm. The processing unit thus revises one of the diagnostic rules into a revised diagnostic rule that initiates reporting of said one or more generated alarms out to a service provider pursuant to the level of intervention indicated by the correlation of the different, first and second key performance indicators.

In another aspect, a computer program product has a tangible computer-readable storage device with computer readable program code embodied therewith, the computer readable program code comprising instructions that, when executed by a computer processing unit, cause the computer processing unit to define baseline key performance indicator values for raw data obtained by data sensors from the operation of each of a plurality of components of an industrial process, and diagnostic rules for triggering alarms as a function of comparing the baseline key performance indicator values to alarm thresholds. The processing unit initiates generating of alarm output data as a function of applying the defined diagnostic rules to historic raw diagnostic data stored in a data repository that is generated by the data sensors during operation of the industrial process components. The processing unit initiates storing in the data repository of the generated alarms in association with the historic raw diagnostic data and with times of acquisition of the historic raw data and times of generation of the alarms. One or more of the generated alarms are analyzed as a function of the historic raw diagnostic data and the times of acquisition of the historic raw data to identify a correlation between different (first and second) ones of the key performance indicators that is indicative of a level of intervention required by a service provider for said one generated alarm. The processing unit thus revises one of the diagnostic rules into a revised diagnostic rule that initiates reporting of said one or more generated alarms out to a service provider pursuant to the level of intervention indicated by the correlation of the different, first and second key performance indicators.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow diagram illustration of a process, system or method for conditional monitoring of the performance of components of an industrial system as a function of key performance indicator data according to an aspect of the present invention.

FIG. 2 is a graphic illustration of a portion of a dashboard display according to an aspect of the present invention.

FIG. 3 is a block diagram illustration of a computerized implementation of an aspect of the present invention.

The drawings are not necessarily to scale. The drawings are merely schematic representations, not intended to portray specific parameters of the invention. The drawings are intended to depict only typical aspects of the invention, and therefore should not be considered as limiting the scope of the invention. In the drawings, like numbering represents like elements.

### DETAILED DESCRIPTION

Any combination of one or more computer readable medium(s) may be utilized. The computer readable medium may be a computer readable signal medium or a computer readable storage medium. Examples of a computer readable storage medium exclude transitory, propagation or carrier wave signals or subject matter and include an electronic, magnetic, optical or semiconductor system, apparatus, or device, or any suitable combination of the foregoing. More specific examples (a non-exhaustive list) of the computer readable storage medium include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium is not a transitory, propagation or carrier wave signal, but instead may be any tangible medium that can contain or store a program for use by or in connection with an instruction execution system, apparatus, or device.

As will be appreciated by one skilled in the art, aspects of the present invention may be embodied as a system, method or computer program product. Accordingly, aspects of the present invention may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. Examples of a computer readable storage medium exclude transitory, propagation or carrier wave signals or subject matter and include an electronic, magnetic, optical or semiconductor system, apparatus, or device, or any suitable combination of the foregoing. More specific examples (a non-exhaustive list) of the computer readable storage medium include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium is not a transitory, propagation or carrier wave signal, but instead may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to aspects of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

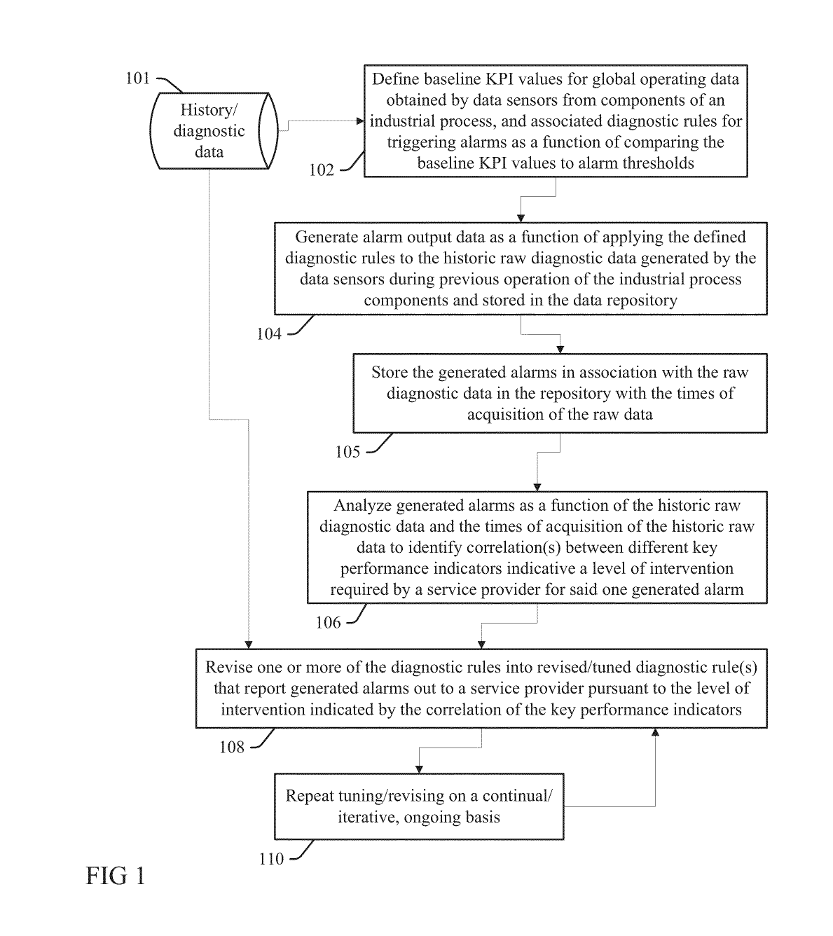

FIG. 1 illustrates a method, process or system for conditional monitoring of the performance of components of an industrial system as a function of key performance indicator (KPI) data. At 102 baseline key performance indicator values are automatically or autonomically (by a processing unit or other automated tool) defined for global operating data obtained by data sensors from a plurality of components of an industrial process, along with and diagnostic rules for triggering alarms as a function of comparing the baseline key performance indicator values to alarm thresholds.

In some aspects the baseline rules are created at 102 as a function of global history data stored in a data repository 101 that includes best experience data generated from the application of diagnostic rules to previous industrial process components and data sensors that are similar to (of the same type, model number, etc.) the present industrial process components and data sensors. Large amounts of history data may be analyzed, and using larger amounts of the data may increase confidence in the resulting baseline diagnostic rules.

Historical raw sensor output data generated by previous operation of the components of an industrial process is stored in the data repository 101. The history data 101 may also be provided globally to other, different industrial process management installations via shared access to the central database (for example, remotely through network ports and access to a single repository or shared/cloud-based file folder).

At 104 the processing unit generates alarm output data as a function of applying the diagnostic rules defined at 102 to the historic raw diagnostic data generated by the data sensors during previous operation of the industrial process components and stored in the data repository 101. At 105 the processing unit stores the generated alarms in association with the raw diagnostic data in the repository 101 and with the times of acquisition of the raw data. More particularly, the generated alarms are correlated to the times of the stored raw, acquired sensor data during the operations of the industrial process components in the data repository 101.

At 106 the processing unit analyzes one of the generated alarms as a function of the historic raw diagnostic data and the times of acquisition of the historic raw data to identify a correlation between different key performance indicators that is indicative a level of intervention required by a service provider for said one generated alarm. At 108 the processing unit tunes or revises one or more of the diagnostic rules into a revised/tuned diagnostic rule(s) that report generated alarms out to a service provider pursuant to the level of intervention indicated by the correlation of the key performance indicators.

More particularly, tuning the rules at 108 includes reducing a number of alarms reported for a first item of the raw diagnostic data meeting a first threshold to a subset of said alarms that are also associated with a correlated second item of the raw diagnostic data meeting a second threshold. In this fashion aspects of the present invention reduce the numbers of alarms reported out to a manageable, threshold maximum level. Tuning the rules at 108 may also include eliminating rules that fail to generate any alarms when applied to the historic raw diagnostic data stored in the data repository 101, or classifying the generated alarms into a plurality of different priority classifications for differential alarm reporting as a function of different respective identified data item correlations.

The tuning at 108 (as well as the baseline definitions at 102) may be accomplished as a function of sensor data outputs and associated alarm data during selected test trial segments of the stored data 101. (It is noted that the terms “trial” and “trail” may be used interchangeably when referring to the segments over time of the sensor output data and alarm data that are used to define and tune the rules and alarm settings at 102 or 108.) For example, given a first test trial data segment that is known by service providers to either include an event or behavior of the system components of concern that should trigger an alarm, or that is known to reflect satisfactory operation of the system components and therefore should not generate an alarm, the rules defined at 102 are applied to the raw sensor data stored for this segment as experimental process inputs during a trial run. The alarms actually generated by the applied rules from the trial run are compared to an expected level of alarms for the test segment, and the rules and alarm settings are tuned in order to align the alarm generation to an expected or desired alarm generation behavior. Step 108 is thus a diagnostic phase that includes an analysis of current state of system and process performance, wherein the results indicate automatic rule tuning or reports or recommendations to service providers for improvement to optimize the system and process performance.

Rules and KPIs and generated alarms may be tested at 108 over selections of different data segments of previously-collected data 101. Alarm frequency may be compared to expected benchmarks (“Did a given rule generate an alarm every time a certain data sensor output was observed, or did the rule fail to generate the alarm?”). Service providers may sift through the collected data 101 to find data that is abnormal and should trigger an alarm, but wherein the rules and KPI's have failed to trigger an alarm, and then create or revise the rules and KPIs (at 102 or 108) to provide alarm notification of future occurrences of the same, abnormal event.

Analyzer rule definition at 102 and tuning at 108 is flexible and enables different type of triggers. Rather than merely define alarm thresholds for KPI values above a number, or oscillating value bands, or simple trending up or trending down behavior, the rules and alarm thresholds may be defined and tuned in response to a service provider reviewing multiple conditions and behaviors found in the pre-recorded data segment.

In some situations a negative system or process event is captured in sensor output data that generally triggers an alarm, but wherein other data indicates that an alarm should not be generated. For example, a first pipe component of an industrial process may have no flow moving through it during a first process executed by other components of the industrial process, and therefore a low-pressure alarm generated for this first pipe during the given process may be irrelevant to system performance, of no use to a service provider in monitoring the components of the industrial process. Accordingly, tuning the rules at 108 may include adding a condition to low-pressure alarm generation for this first pipe, wherein the low-pressure alarm may not be generated if the other components of the industrial process industrial process are executing the first process.

Conditional KPI collection rules may also be generated during tuning steps at 108. For example, if determined that there will not be a flow through the first pipe during a certain timeframe or infrastructure condition, tuning at 108 may include not calculating a KPI associated with the flow through said pipe when this condition or time frame occurs, which obviate the possibility of generating an alarm for flow through the pipe, as the first pipe is not active in any industrial process at the present time. KPI's may thus be recognized in proportional priority to relevant process problems that actually need service provider attention, and to further tune to a specific infrastructure site over time through test trials.

Though initial, pre-build rule definitions at 102 may omit needed rules, the process at 108 is responsive to sensor outputs and adjusts and learns rule definitions and refinements on an ongoing process. The storing of raw sensor output data in association with alarm generation over time in the data repository 101 also enables the recognition of the need for new or revised rules to also generate alarms that previously would have been unrecognized or lost, as is discussed more fully below. A feedback step at 110 loops back through the tuning step 108, for example on a continual, ongoing basis, in some aspects iteratively based on periodic time triggers at 110. Thus, aspects of the present invention continually fine tune and improve condition monitoring by the industrial process sensor outputs. This ongoing refinement process differentiates aspects of the present invention from other condition monitors that use and apply a fixed set of rules, KPI's and alarm triggers.

Tuning at 108 may include pruning rules and alarm thresholds that never trigger an alarm, saving system resources going forward that are required to apply and maintain said rules/triggers and store data associated therewith. Rules and triggers that continually generate alarms during component operations may also be dropped, or tuned to reduce alarm frequencies and numbers, as technicians are likely to ignore continually-sounding alarms, or to manually change the associated thresholds to reduce the alarms (which may result in failing to respond to certain KPI value triggers that should be noted).

Tuning at 108 to adjust the rules or thresholds to generate conditional alarms may include conditioning alarms on the generation of other alarms from the raw sensor data over the same time period, wherein the combination of the two alarms indicates that there is truly a problem. Thus in some aspects a first rule that triggers too many alarms, or alarms at a frequency exceeding a set value, may be tuned at 108 to trigger an alarm only when another, second rule or trigger trips another second alarm that indicates a problem worthy of attention when issued in combination with the continually-sounding alarm in the historical or trial data 101.

Tuning at 108 need not suppress the numbers of over-active alarms, but rather identifies other sensor data behavior provides checks and balances on reporting of the alarms, so that the alarms are brought to the attention of service personnel only when action to correct is truly needed as indicated by the presence of other conditions in the sensor data 101. By responding to sensor data within a wide variety of different component deployments aspects of the present invention provide global tracking of good and bad rules, tuning the rules and otherwise learning rule and alarm trigger conditions as the sensor data is acquired.

Defining and tuning the rule and alarm thresholds at 102 and 108 may also include categorizing and prioritizing alarms to different ranges or labels of conditions. Some aspects use low, medium and high priority categories or conditions, For example, a low condition indicates a maintenance activity that should be performed during the next scheduled downtime, and thus associated alarms need only be signaled or reported at the time of the scheduled maintenance. In contrast, recognition that another alarm is a high priority alarm condition indicates that immediate intervention is warranted to solve an underlying problem, and therefore service personnel are immediately notified of the alarm generation. A medium condition alarm may be one that merits attention in periodic (weekly, monthly, daily, etc.) reporting for suggested service and intervention on a periodic basis or first opportunity prior to a next scheduled downtime. Such priority classification may also be conditional on other raw data or alarm generation behaviors, for example revising a priority if another defined condition or context is also present: thus, a medium priority alarm recognized as associated with a high-value process that present a high potential risk of loss that outweighs the cost of triggering an intervention prior to the next scheduled downtime may be upgraded to a high priority alert.

Aspects may prioritize alarms based on criticality of alarm event, which also triggers an appropriate notification method. The process provides for ongoing, advanced condition monitoring at 110 that continues to collect data and monitor rules and KPIs and report prioritized alarms for appropriate action to ensure continued optimized system and process performance. Based on severity of alarm an appropriate intervention is triggered to sustain the highest level of system and process performance. The feedback process at 110 ensures that KPI monitoring via the rules and threshold does not degrade over time, as service personnel may actively respond and correct for abnormal conditions.

Conditional rule and threshold tuning at 108 reduces false alarms by identifying secondary conditions that must also be met to trigger an initially defined alarm. For example, in response to an alarm triggered by an excessive temperature output by a first sensor, the stored historic data 101 may be considered at 108 to determine a correlation with a minimum rate-of-rise of the temperature over time that is found to occur when problems in the deployed infrastructure are truly manifested. Accordingly, tuning an associated rule at 108 may include conditioning issuance of an alarm to when said temperature output exceeds the temperature threshold and when the rate-of-rise of the temperature also meets the observed minimum rate-of-rise of the temperature. Thus, the number of alarms may be reduced to a frequency that merits attention and can be satisfied by available maintenance resources. Stated another way, for temperature observations, service determination needs more data than “how hot?,” but also “how fast did temperature ramp up?”, providing a deeper analysis that needs to be evaluated.

Saving raw sensor output data in the data repository 101 aligned to alarm events enables detailed and effective human trouble shooting, as alarm and data are considered in context with each other and together. In contrast, conventional analyzers tend to generate too many alarms, and are accordingly often shut down, and further, when service personnel attempt to analyze the alarms the underlying data that caused the alarm is unsaved and unavailable.

Condition monitors may be tuned at 108 based on known inputs (stored data) and trial runs rather than years of real time learning through negative alarm events. Example data segments may be stored for trial runs for analysis with respect to the latest/current KPIs and rules, enabling trials or experiments to evaluate effectiveness and tune accordingly at 108, tuning condition monitoring without requiring process loss and negative consequences associated with shutting down the monitored system infrastructure. Thus, aspects provide conditional monitoring that is able to focus on true, recognized alarm conditions that must be resolved, and which may continually adjust to and learn industrial system and process behavior.

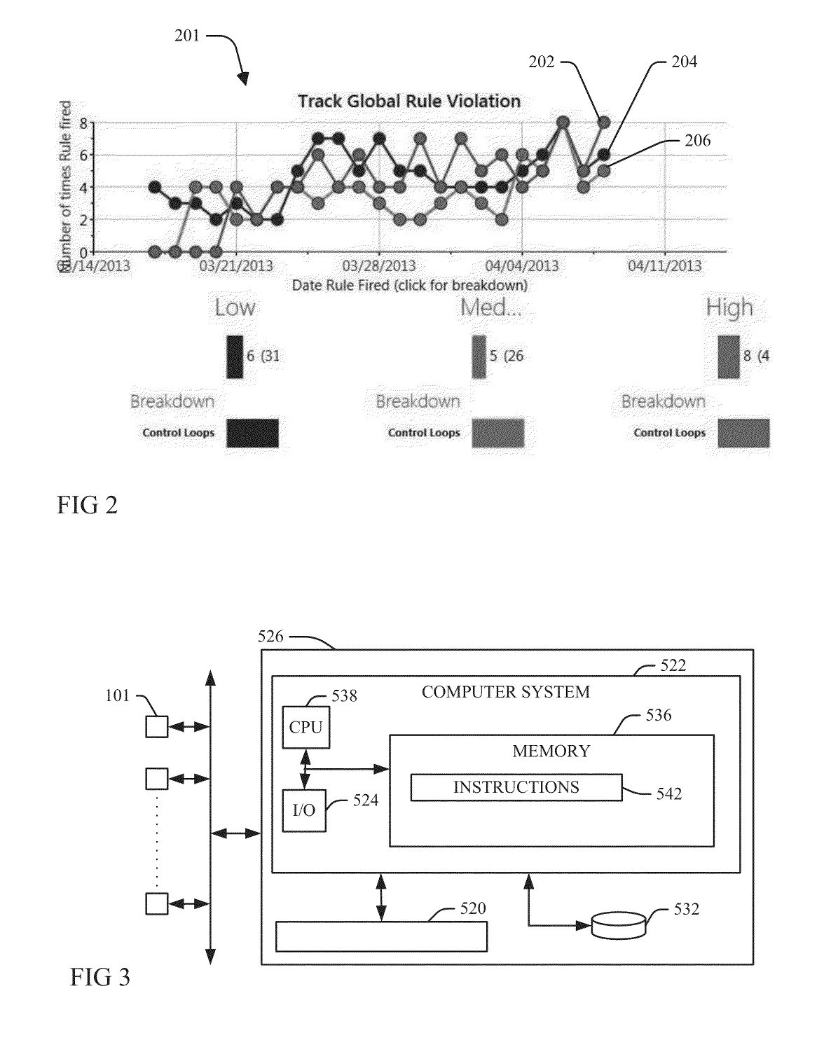

Aspects may also provide condition monitoring by aggregating different KPI analyses to a single dashboard, such as within the alarm status summary 201 displayed in FIG. 2. Several different and unique KPI analysis services 202, 204 and 206 with different priorities are shown in the alarm status summary 201 (for example, cyber security, distributed control system, etc.) that may each run at the same time in the same condition monitoring system. By displaying multiple data analysis outputs in one display dashboard service providers can quickly look at the health and performance of the entire system and industrial process from a single dashboard. For example, though none of the three KPI analysis services 202, 204 or 206 may be presently exceeding associated alarm thresholds, it is apparent that each is trending upward over time, which may communicate a need for intervention to service personnel as the trend indicates that one or more alarm conditions are likely to occur in the future, or that the system performance considered as a whole is degrading. Thus, aspects of the present invention enable a new level of KPI analysis. In contrast, the definition of rules and alarms conditional on multiple, different data analysis outputs may not be practical when deployed in separate, unassociated and standalone systems and displays, as is common in the prior art.

Conventional, prior art condition monitoring service products are generally based on a “black box,” Boolean logic-based (right or wrong) approach that results in too many alarms, and cannot distinguish alarm conditions that evince subtle differences or variations in data that become apparent only when considered in the context of other data outputs. An overabundance of false or low priority alarms is a major downfall of any conditioned monitoring system. If alarms are false, not critical or not actionable the entire credibility of the conditioned monitoring system is at stake. Alarm systems may be eventually shut down or ignored by service personnel due to incessant alarm generation in the prior art.

Aspects of the present invention provide condition monitoring as a function of logic and intervention to bring order to a pure Boolean Logic mode of operation and alarm reporting. Prior art condition monitor does not properly align the raw data that triggers an original alarm with the alarm itself, but instead the raw data is only available by going back through a time-consuming process sorting of the data, and this is still only possible when historical data is actually saved. Aspects of the present invention properly align the stored raw system and industrial process data 101 to the rules and KPI's of the condition monitoring. With the underlying analysis data and KPI's rules aligned, required intervention can be more appropriately determined based on the severity of an alarm. Data alignment with rules allows significantly improved conditioned monitoring of abnormal conditions before there is a more catastrophic failure. It is not a major achievement to report on an abnormal condition when it has already occurred and caused process downtime. However, through deeper analysis of data patterns aspects of the present invention predict and report initial process issues before a more expensive catastrophic event occurs.

By tuning alarm conditions at 108 based on past data and experiences, and on testing the tuned rules on real system and process data stored in the data repository 101 to complete trial runs, the outputs generated by the trial runs of previously collected data are used to determine new rules and KPI's and corresponding alarm triggers. As additional data for the system and process is collected and stored in the data repository 101 and analyzed at each iteration triggered at 110, the process may determine new rules and KPI's to report alarms and sustain high level performance by fixing alarm issues. Long-term, track-level monitoring is achieved that is predictive to respond to changing conditions before there is a catastrophic event. The more data analyzed, the higher confidence the alarm reporting becomes, which is also quickly adapted to changing conditions.

Where multiple installation share global tuning and KPI rules, individual sites benefit from both local tuning of their local system and process and global feedback received from other, similar or analogous processes. A database of relevant high value rules can be shared globally. Globally prioritizing alarms are also as to level of priority (for example, high, medium or low) also leverages data observation from many different installations to more accurately set the priority of the alarm notification from highest priority (“fix it now”) through one or more lower levels (“fix it at the next, general or scheduled maintenance activity”).

Tuning at 108 may also be customized responsive to individualized system or customer needs. When multiple system and process services are provided there is a new opportunity to analyze the overall interaction between services. A dashboard may provide an aggregate view of the interaction between individual services, a single place customers can go to view the overall system and process performance.

Aspects provide a predictive analyzer attribute at 108, not just a primitive Boolean alarm reporting. Thus, adjustments may be made to the monitored components before a catastrophic event occurs. For example, in a paper machine implementation conventional analyzers might just track the number of sheet breaks at a customer site. Paper process facility operators are generally well aware when a sheet has broken, and generating an alarm for this condition has little value. Rather, facility operators want to receive alarms at an appropriate time before the sheet break occurs, in order to take preventive measures. This requires historical and contextual/conditional analysis via a predictive analyzer at 108, so that adjustments may be made before a catastrophic event occurs, to enable process adjusts to prevent the negative process event, in effect to predict when a failure is about to occur. An object of aspects of the present invention is to balance preventive and corrective maintenance in order to minimize machine/process downtime.

Aspects of the present invention pre-test rules on pre-collected data segment to further evaluate the rule. Previous condition monitors define and implement rules and then generally require a month of operating the infrastructure under the applied rules to determine how many alarms are triggered, and then the number of alarms is considered over the relatively long history time period for improving the logic of the associated condition. It generally takes several months to fine tune the logic through this process, and by this time a catastrophic and costly event could have already occurred. In contrast, aspects of the present invention test define and tune rules at 102 and 108 on data segments that have already occurred and collected in the data repository 101.

Aggregating data outputs from different services in a single dashboard view 201 enables a visual analysis wherein service providers may quickly look at the health and performance of the entire system and industrial process. This also allows immediate links and access to the raw data 101 of the displayed service analysis data generated therefrom for service provider interaction to validate system and process abnormalities. The dashboard provides a common navigation in to a single condition monitoring system, rather than requiring the use of several separate and disconnected systems or portals. In one aspect this enables engineers to code rules and KPI's and associated alarms between systems. All channels are run in a same operator navigation environment. While each service port channel application service is unique on its own, there is a clear synergy, with a combining of several applications that enables a high layer of inter-application data analysis, visualization, rules, KPI's and alarm reporting.

Daily status reporting may be provided that includes several different diagnostic or service applications. In one example the dashboard view 201 provides a daily “Top 10 report” with different prioritized status indicators 202, 204 and 206 associated with each of different, reported service outputs. Such status reports may further provide detailed and actionable plans of implementation for associated periodic meetings at implementation sites, detailing what is working well and what needs attention and prioritizing a key action plan.

Aspects of the present invention may be implemented with ServicePort™ Explorer Service Delivery Devices provided by ABB, Inc., and installed on-site at a customer's plant or other local geographic location in communication via a secure tunnel to each of a plurality of customer systems or process elements in a secure manner on the local site. (SERVICEPORT is a trademark of ABB Group in the United States or other countries.) The ServicePort™ Explorer Device outputs reports, alarms, service plans, etc., that it generates from raw sensor and other data received from systems or process elements by use of one or more automated service tool applications, and wherein the data repository 101 may be kept on-site and confidential from experts located off-sight (at one or more remote locations). Generated output information may also be used by off-sight service experts to provide additional off-site analysis or services. ServicePort™ explorer devices may also transform the collected data into reports and other data representations that are informative of process performances without divulging the underlying raw data, and said data representations may be used as inputs for the rule definition and application steps at 102 or 108 instead of the raw sensor data. In such implementations off-site experts may remotely view, analyze, diagnose and correct on-site issues through outputs generated by ServicePort™ explorer service delivery devices while the raw data may be kept confidential and on-site.

Referring now to FIG. 3, an exemplary computerized implementation of an aspect of the present invention includes a computer system or other programmable device 522 in communication 520 with one or more of the data repository 101 of FIG. 1. The programmable device 522 provides conditional monitoring of the performance of components of an industrial system as a function of key performance indicator data as described above with respect to FIGS. 1 and 2. Instructions 542 reside within computer readable code in a computer readable memory 516, or in a computer readable storage system 532, or other tangible computer readable storage medium 534 that is accessed by a Central Processing Unit (CPU) 538 of a computer system or infrastructure 523 of the mobile device 522. Thus, the instructions, when implemented by the processing unit 538, cause the processing unit 538 to provide conditional monitoring of the performance of components of an industrial system as a function of key performance indicator data as described above with respect to FIGS. 1 and 2.

In one aspect, the present invention may also perform process steps of the invention on a subscription, advertising, and/or fee basis. That is, a service provider could offer to integrate computer-readable program code into the computer system 522 to enable the computer system 522 to provide conditional monitoring of the performance of components of an industrial system as a function of key performance indicator data as described above with respect to FIGS. 1 and 2. The service provider can create, maintain, and support, etc., a computer infrastructure, such as the computer system 522, network environment 520, or parts thereof, that perform the process steps of the invention for one or more customers. In return, the service provider can receive payment from the customer(s) under a subscription and/or fee agreement. Services may include one or more of: (1) installing program code on a computing device, such as the computer device 522, from a tangible computer-readable medium device 532 or 534; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for conditionally monitoring the performance of components of an industrial system as a function of key performance indicator data, the method comprising:
defining by a processing unit baseline key performance indicator values for raw data obtained by data sensors from the operation of each of a plurality of components of an industrial process;
the processing unit defining diagnostic rules for triggering alarms as a function of comparing the baseline key performance indicator values to alarm thresholds;
the processing unit initiating a generating of alarm output data as a function of applying the defined diagnostic rules to historic raw diagnostic data generated by the data sensors during operation of the industrial process components and stored in a data repository in communication with the processing unit;
the processing unit initiating a storing in the data repository of the generated alarms in association with the historic raw diagnostic data and with times of acquisition of the historic raw data and times of generation of the alarms;
the processing unit analyzing one of the generated alarms as a function of the historic raw diagnostic data and the times of acquisition of the historic raw data to identify a correlation between a first and a second of the key performance indicators that is indicative of a level of intervention required by a service provider for said one generated alarm; and
the processing unit revising one of the diagnostic rules into a revised diagnostic rule that initiates reporting of said one generated alarm out to a service provider pursuant to the level of intervention indicated by the correlation of the first and second key performance indicators.

2. The method of claim 1, further comprising:
integrating computer-readable program code into a computer system comprising the processing unit, a computer readable memory and a computer readable tangible storage device, wherein the computer readable program code is embodied on the computer readable tangible storage device and comprises instructions that, when executed by the processing unit via the computer readable memory, cause the processing unit to perform the steps of the defining the baseline key performance indicator values and the diagnostic rules, the initiating the generating of the alarm output data and the storing in the data repository of the generated alarms in association with the historic raw diagnostic data and with the times of historic raw data acquisition and alarm generation, the analyzing the one generated alarm as the function of the historic raw diagnostic data and the times of acquisition of the historic raw data to identify the correlation between the first and the second key performance indicators indicative of the level of intervention required by the service provider for said one generated alarm, and the revising the one diagnostic rule into the revised diagnostic rule that initiates reporting of the one generated alarm out to a service provider pursuant to the level of intervention indicated by the correlation of the first and second key performance indicators.

3. The method of claim 1, wherein the step of revising the one diagnostic rule comprises revising said one diagnostic rule to reduce a number of alarms reported for a first item of the raw diagnostic data meeting a first threshold of the first key performance indicator to a subset of said alarms that are also associated with a second item of the raw diagnostic data meeting a second threshold of the correlated second key performance indicator.

4. The method of claim 1, wherein the step of revising the one diagnostic rule comprises eliminating said rule for failing to generate any alarms when applied to the historic raw diagnostic data stored in the data repository for the first and the second key performance indicators.

5. The method of claim 1, wherein the step of revising the one diagnostic rule comprises classifying alarms generated by application of said one diagnostic rule to the historic raw diagnostic data stored in the data repository into a plurality of different priority classifications for differential alarm reporting as a function of different respective identified data item correlations to each of the first and the second key performance indicators.

6. The method of claim 1, wherein the step of revising the one diagnostic rule comprises:
defining a first threshold for a value of the first key performance indicator;
observing each of different values of the first key performance indicator over a time period; and
conditioning reporting of said one generated alarm out to the service provider upon the value of the first key performance indicator meeting the defined threshold, and the different values of the first key performance indicator trending upward or downward over the period of time.

7. The method of claim 1, wherein the step of revising the one of the diagnostic rules comprises:
determining that a value of the first key performance indicator that is generated from the sensor data is not relevant to a quality of an industrial process executed by a specific component of the industrial process, wherein said one generated alarm is generated in response to the value of the first key performance indicator; and
conditioning reporting of said one generated alarm out to the service provider by not reporting out said one generated alarm if the industrial process executed by the specific component of the industrial process is active.

8. The method of claim 1, wherein the step of revising the one of the diagnostic rules comprises:
observing different values for each of the first and second key performance indicators over a time period; and
conditioning reporting of said one generated alarm out to the service provider upon the different values of the values of the first and second key performance indicators each trending upward or downward over the period of time.

9. A system, comprising:
a processing unit in communication with a computer readable memory and a tangible computer-readable storage device;
wherein the processing unit, when executing program instructions stored on the tangible computer-readable storage device via the computer readable memory:
defines baseline key performance indicator values for raw data obtained by data sensors from the operation of each of a plurality of components of an industrial process;
defines diagnostic rules for triggering alarms as a function of comparing the baseline key performance indicator values to alarm thresholds;
initiates generation of alarm output data as a function of applying the defined diagnostic rules to historic raw diagnostic data generated by the data sensors during operation of the industrial process components and stored in a data repository in communication with the processing unit;
initiates storage in the data repository of the generated alarms in association with the historic raw diagnostic data and with times of acquisition of the historic raw data and generation of the alarms;
analyzes one of the generated alarms as a function of the historic raw diagnostic data and the times of acquisition of the historic raw data to identify a correlation between a first and a second of the key performance indicators that is indicative a level of intervention required by a service provider for said one generated alarm; and
revises one of the diagnostic rules into a revised diagnostic rule that reports said one generated alarm out to a service provider pursuant to the level of intervention indicated by the correlation of the first and the second key performance indicators.

10. The system of claim 9, wherein the processing unit, when executing the program instructions stored on the computer-readable storage device via the computer readable memory, revises said one diagnostic rule to reduce a number of alarms reported for a first item of the raw diagnostic data meeting a first threshold of the first key performance indicator to a subset of said alarms that are also associated with a second item of the raw diagnostic data meeting a second threshold of the correlated second key performance indicator.

11. The system of claim 9, wherein the processing unit, when executing the program instructions stored on the computer-readable storage device via the computer readable memory, revises the one diagnostic rule by eliminating said rule for failing to generate any alarms when applied to the historic raw diagnostic data stored in the data repository for the first and the second key performance indicators.

12. The system of claim 9, wherein the processing unit, when executing the program instructions stored on the computer-readable storage device via the computer readable memory, revises the one diagnostic rule by classifying alarms generated by application of said one diagnostic rule to the historic raw diagnostic data stored in the data repository into a plurality of different priority classifications for differential alarm reporting as a function of different respective identified data item correlations to each of the first and the second key performance indicators.

13. The system of claim 9, wherein the processing unit, when executing the program instructions stored on the computer-readable storage device via the computer readable memory, revises the one diagnostic rule by:
defining a first threshold for a value of the first key performance indicator;
observing each of different values of the first key performance indicator over a time period; and
conditioning reporting of said one generated alarm out to the service provider upon the value of the first key performance indicator meeting the defined threshold, and the different values of the first key performance indicator trending upward or downward over the period of time.

14. The system of claim 9, wherein the processing unit, when executing the program instructions stored on the computer-readable storage device via the computer readable memory, revises the one of the diagnostic rules by:
determining that a value of the first key performance indicator that is generated from the sensor data is not relevant to a quality of an industrial process executed by a specific component of the industrial process, wherein said one generated alarm is generated in response to the value of the first key performance indicator; and
conditioning reporting of said one generated alarm out to the service provider by not reporting out said one generated alarm if the industrial process executed by the specific component of the industrial process is active.

15. The system of claim 9, wherein the processing unit, when executing the program instructions stored on the computer-readable storage device via the computer readable memory, revises the one of the diagnostic rules by:
observing different values for each of the first and second key performance indicators over a time period; and
conditioning reporting of said one generated alarm out to the service provider upon the different values of the values of the first and second key performance indicators each trending upward or downward over the period of time.

16. A computer program product for conditionally monitoring the performance of components of an industrial system as a function of key performance indicator data, the computer program product comprising:
a computer readable tangible storage device having computer readable program code embodied therewith, the computer readable program code comprising instructions that, when executed by a computer processing unit, cause the computer processing unit to:
define baseline key performance indicator values for raw data obtained by data sensors from the operation of each of a plurality of components of an industrial process;
define diagnostic rules for triggering alarms as a function of comparing the baseline key performance indicator values to alarm thresholds;
initiate generation of alarm output data as a function of applying the defined diagnostic rules to historic raw diagnostic data generated by the data sensors during operation of the industrial process components and stored in a data repository in communication with the processing unit;
initiate storage in the data repository of the generated alarms in association with the historic raw diagnostic data and with times of acquisition of the historic raw data and generation of the alarms;
analyze one of the generated alarms as a function of the historic raw diagnostic data and the times of acquisition of the historic raw data to identify a correlation between a first and a second of the key performance indicators that is indicative a level of intervention required by a service provider for said one generated alarm; and
revise one of the diagnostic rules into a revised diagnostic rule that reports said one generated alarm out to a service provider pursuant to the level of intervention indicated by the correlation of the first and the second key performance indicators.

17. The computer program product of claim 16, wherein the computer readable program code instructions, when executed by the computer processing unit, further cause the computer processing unit to revise said one diagnostic rule to reduce a number of alarms reported for a first item of the raw diagnostic data meeting a first threshold of the first key performance indicator to a subset of said alarms that are also associated with a second item of the raw diagnostic data meeting a second threshold of the correlated second key performance indicator.

18. The computer program product of claim 16, wherein the computer readable program code instructions, when executed by the computer processing unit, further cause the computer processing unit to revise the one diagnostic rule by eliminating said rule for failing to generate any alarms when applied to the historic raw diagnostic data stored in the data repository for the first and the second key performance indicators.

19. The computer program product of claim 16, wherein the computer readable program code instructions, when executed by the computer processing unit, further cause the computer processing unit to revise the one diagnostic rule by classifying alarms generated by application of said one diagnostic rule to the historic raw diagnostic data stored in the data repository into a plurality of different priority classifications for differential alarm reporting as a function of different respective identified data item correlations to each of the first and the second key performance indicators.

20. The computer program product of claim 16, wherein the computer readable program code instructions, when executed by the computer processing unit, further cause the computer processing unit to revise the one diagnostic rule by:
defining a first threshold for a value of the first key performance indicator;
observing each of different values of the first key performance indicator over a time period; and
conditioning reporting of said one generated alarm out to the service provider upon the value of the first key performance indicator meeting the defined threshold, and the different values of the first key performance indicator trending upward or downward over the period of time.
